(19) United States
(12) Patent Application Publication
(10) Pub. No.: US 2012/0084009 A1
(43) Pub. Date: Apr. 5, 2012

(54) REFINED LITHOLOGY CURVE

(75) Inventors: Jean-Baptiste Peyaud, East Perth (AU); Adriaan A. Bal, Perth (AU)

(73) Assignee: BAKER HUGHES INCORPORATED, Houston, TX (US)

(21) Appl. No.: 13/081,565

(22) Filed: Apr. 7, 2011

Related U.S. Application Data
(60) Provisional application No. 61/321,626, filed on Apr. 7, 2010.

(51) Int. Cl. G06F 19/00; G01V 5/08

(52) U.S. Cl. 702/7

(57) ABSTRACT

A method for estimating a property of an earth formation penetrated by a borehole. The method includes: conveying a natural radiation detector through the borehole and measuring natural radiation emitted from the earth formation to provide natural radiation data; conveying a neutron source through the borehole and irradiating the earth formation with neutrons; measuring neutron-interaction radiation emitted from the earth formation due to the irradiating with at least one neutron-interaction radiation detector to provide neutron-interaction data; conveying a borehole image logging tool through the borehole and measuring a resistivity of the earth formation by transmitting electrical current or electromagnetic energy into the earth formation and receiving an electrical signal associated with the resistivity due to the transmitting to provide resistivity data; and combining the natural radiation data, the neutron-interaction radiation data, and the resistivity data into one data set as a function of depth to estimate the property.

### CROSS REFERENCE TO RELATED APPLICATIONS

This application claims the benefit of an earlier filing date from U.S. Provisional Application Ser. No. 61/321,626 filed Apr. 7, 2010, the entire disclosure of which is incorporated herein by reference.

### BACKGROUND OF THE INVENTION

1. Field of the Invention

The present invention relates to processing data from different logging tools to provide a presentation of the data that is more detailed than the individual data from each logging tool.

2. Description of the Related Art

Exploration and production of hydrocarbons require accurate and detailed knowledge of earth formations that may contain reservoirs of the hydrocarbons. For example, it is important to know the lithology of the earth formations as a function of depth.

The lithology may be determined using several techniques. One technique involves obtaining core samples of the earth formation. Analysis of the core samples in a laboratory can provide detailed knowledge of the lithology. While core samples can provide the detailed knowledge petro-analysts and geophysicists desire, obtaining the samples from deep within the earth can be costly and time consuming.

Another way to determine the lithology of an earth formation is with a neutron logging tool conveyed through a borehole penetrating the earth formation. This type of logging tool irradiates the formation with neutrons that cause interactions with materials in the formation. The interactions emit gamma rays with energy levels characteristic of a material with which the neutrons interact. By detecting the gamma rays, the materials can be identified. Measurements are performed by the neutron logging tool at various depths in the borehole. Each measurement is associated with a depth at which the measurement is performed to produce a log. Unfortunately, neutron logging provides a coarse vertical resolution (i.e., resolution along the longitudinal axis of the borehole) of about two feet in some embodiments and may not accurately locate boundaries separating layers of different materials.

Therefore, what are needed are techniques to determine the lithology of an earth formation and associated boundaries without the need for core samples.

### BRIEF SUMMARY OF THE INVENTION

Disclosed is a method for estimating a property of an earth formation penetrated by a borehole. The method includes: conveying a natural radiation detector through the borehole and measuring natural radiation emitted from the earth formation to provide natural radiation data; conveying a neutron source through the borehole and irradiating the earth formation with neutrons; measuring neutron-interaction radiation emitted from the earth formation due to the irradiating with at least one neutron-interaction radiation detector to provide neutron-interaction data; conveying a borehole image logging tool through the borehole and measuring a resistivity of the earth formation by transmitting electrical current or electromagnetic energy into the earth formation and receiving an electrical signal associated with the resistivity due to the transmitting to provide resistivity data; and combining the natural radiation data, the neutron-interaction radiation data, and the resistivity data into one data set as a function of depth to estimate the property.

Also disclosed is an apparatus for estimating a property of an earth formation penetrated by a borehole. The apparatus includes: a natural radiation detector conveyable through the borehole and configured to measure natural radiation emitted from the earth formation to provide natural radiation data; a neutron source conveyable through the borehole and configured to irradiate the earth formation with neutrons; at least one neutron-interaction radiation detector configured to measure neutron-interaction radiation due to the irradiated to provide neutron-interaction radiation data; a borehole image logging tool conveyable through the borehole and configured to measure a resistivity of the earth formation by transmitting electrical current or electromagnetic energy into the earth formation and receiving an electrical signal associated with the resistivity to provide resistivity data; and a processor configured to combine the natural radiation data, the neutron-interaction radiation data, and the resistivity data into one data set as a function of depth to estimate the property.

Further disclosed is a non-transitory computer-readable storage medium having computer-executable instructions for estimating a property of an earth formation penetrated by a borehole by executing a method that includes: measuring natural radiation emitted from the earth formation to provide natural radiation data; measuring neutron-interaction radiation emitted from the earth formation due to irradiating the formation with neutrons to provide neutron-interaction data; measuring a resistivity of the earth formation to provide resistivity data; and combining the natural radiation data, the neutron-interaction radiation data, and the resistivity data into one data set as a function of depth to estimate the property.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a logging tool disposed in a borehole penetrating the earth;

FIG. 2 illustrates an exemplary embodiment of neutron-interaction logging components in the logging tool;

FIG. 3 presents one example of seven lithotype facies defined from neutron-interaction radiation data in tenary plots of (Ca+Mg)/Fe/Al;

FIG. 4 illustrates an exemplary embodiment of borehole image logging components in the logging tool;

FIG. 5 presents one example of an image of the borehole derived from borehole image logging data;

FIG. 6 presents one example of a Refined Lithology (RLIT) curve; and

FIG. 7 presents one example of a method for estimating a property as a function of depth in the borehole.

### DETAILED DESCRIPTION OF THE INVENTION

Disclosed are exemplary embodiments of techniques for estimating a lithology of an earth formation with high vertical resolution. The techniques, which include method and apparatus, call for obtaining lithotype facies from a natural gamma radiation log, a neutron-interaction radiation log, and any high-resolution borehole image log, for example a resistivity log. The natural gamma radiation log and the neutron-induced radiation log provide accurate identification of lithotype facies but with a coarse vertical resolution of approximately two feet in some tools. A high-resolution borehole image log provides accurate vertical resolution of resistivity and changes in resistivity as small as a few millimeters but with limited ability to identify lithotype facies or minerals. With the borehole image log, locations of formation bed boundaries can be identified to within a few millimeters in one embodiment. In order to present accurate lithotype facies with improved vertical resolution, the techniques call for combining the best attributes of the natural-gamma radiation log, the neutron-interaction radiation log, and the borehole image log into one data set. Hence, the techniques use the bed boundaries identified by the borehole image log and the lithotype facies identified by the natural radiation log and the neutron-interaction radiation log. The limited lithotype facies or minerals identified by the borehole image log can be used as a crosscheck for quality control.

The resulting data set can be presented to an operator, a petro-analyst, or geophysicist on a display or printed paper using various colors, textures, and shading to identify the lithotype facies as a function of depth. This data set or log is referred to herein as the “refined lithology” or RLIT. The RLIT may be viewed as a “virtual core” of the earth formation under investigation.

It is important to use both the natural radiation log and the neutron-interaction log in order to be able to identify a wide variety of lithotype facies. For example, the natural gamma radiation log is used to identify shale. Radioactive potassium, thorium and uranium all emit natural gamma rays. These three elements account for the majority of natural radiation in sedimentary formations. Potassium and thorium are generally found in shale (i.e., illite) and sandstones (i.e., orthoclase, illite). Uranium on the other hand may be found in sands, shales and some carbonates. Other lithotype facies can be identified using the neutron-interaction radiation log.

Before the techniques are discussed in detail, certain definitions are presented. The term “lithotype facies” relates to a body of rock having a certain characteristic. The term “electrofacies” relates to a body of rock having a certain physical characteristic such as resistivity or its inverse conductivity.

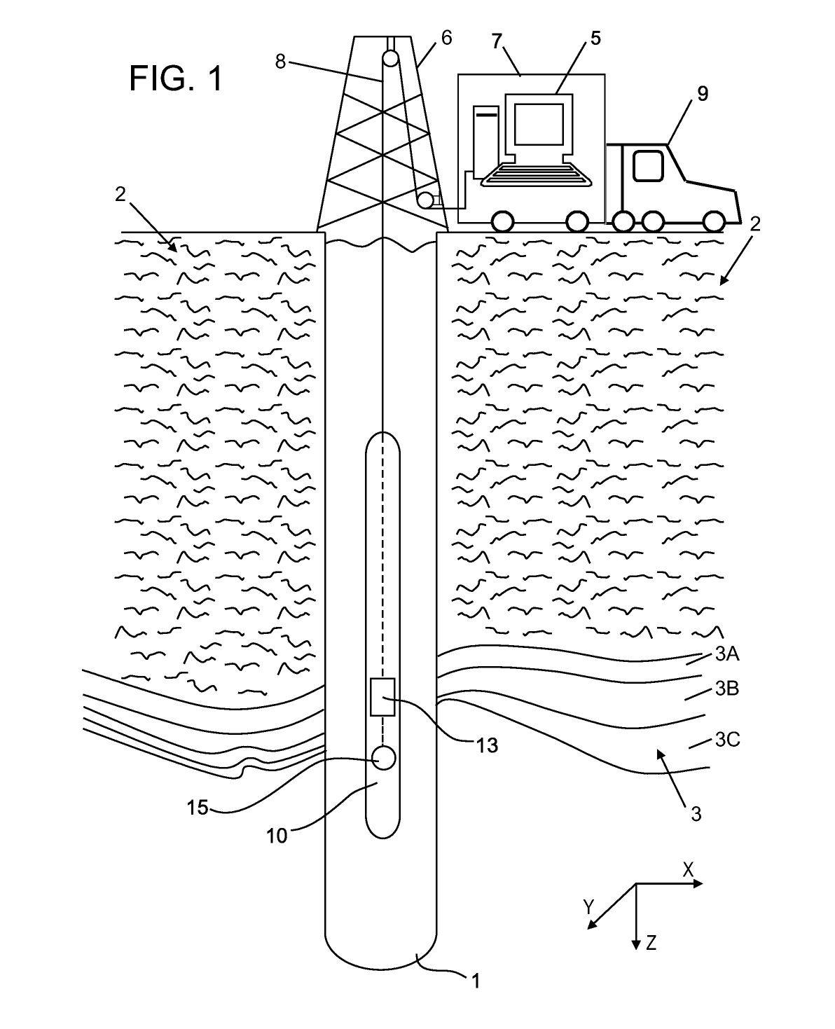

Apparatus for implementing the techniques disclosed herein is now discussed. Reference may now be had to FIG. 1. FIG. 1 illustrates an exemplary embodiment of a well logging instrument 10 (also referred to as a “tool”) for wireline logging shown disposed in a wellbore 1 (also referred to as a borehole). The wellbore 1 generally penetrates a formation 3 that can include various intervals or layers shown as 3A, 3B and 3C. One skilled in the art will recognize that the various geological features as may be encountered in a subsurface environment may be referred to as “formations.” As used herein, the term “formation” also includes the subsurface materials that makeup the formation. For example, the formation can include a rock matrix of pores filled with one or more fluids such as water, oil or gas and the like. Non-limiting examples of materials forming the rock matrix include sandstone, limestone, dolomite, or combinations of other rocks or minerals. As a matter of convention, a depth of the wellbore 1 is described along a Z-axis, while a cross-section is provided on a plane described by an X-axis and a Y-axis. Prior to well logging with the logging instrument 10, the wellbore 1 is drilled into the Earth 2 using a drilling rig.

The logging instrument 10 is lowered into the wellbore 1 using a wireline 8 (or slickline) deployed by a derrick 6 or similar equipment. Generally, the wireline 8 includes suspension apparatus, such as a load bearing cable, as well as other apparatus. The other apparatus may include a power supply, a communications link (such as wired or optical) and other such equipment. Generally, the wireline 8 is conveyed from a service truck 9 or other similar apparatus (such as a service station, a base station, etc. . . . ). Often, the wireline 8 is coupled to topside equipment 7. The topside equipment 7 may provide power to the logging instrument 10, as well as provide computing and processing capabilities for at least one of control of operations and analysis of data. Hence, the topside equipment 7 can include a computer processing system 5. Local control and/or communication capabilities of the logging tool 10 can be provided by downhole electronics 13. In another embodiment, the logging tool 10 is conveyed through the borehole 1 by a drill string or coiled tubing while the borehole 1 is being drilled in a technique referred to as logging-while-drilling (LWD). In LWD, the logging tool 10 performs measurements while the borehole is being drilled or during a temporary halt in drilling.

Logging is generally performed in an open borehole such as with LWD depending on the type of logging tool 10 or it can be performed in a cased borehole in certain situations. In a cased borehole, the casing includes a pipe with cement filled between the pipe and the formation 3. When the logging tool 10 is run through a cased borehole, elements in the pipe, the cement, and the formation will interact with the neutrons and generate gamma rays. The cement can be the main problem if its exact composition is not known and it contains elements that could be legitimately present in the formation (e.g., calcium). In order to get an accurate reading of the elements in the formation, elements present in the pipe and the cement must be removed from the measurements in a process called “environmental correction.” Environmental correction requires several types of information concerning the pipe and the cement such as their composition and mass as a function of depth in the borehole in order to remove their effects on the formation measurements.

The logging tool 10 includes components 15 for performing logging measurements of the earth formation 3. The components 15 include a natural gamma radiation detector, neutron-interaction logging components and/or borehole image logging components. The different logging components may all be disposed at one tool 10 or at different tools 10. The various logs may be obtained by wireline logging or LWD or some combination thereof.

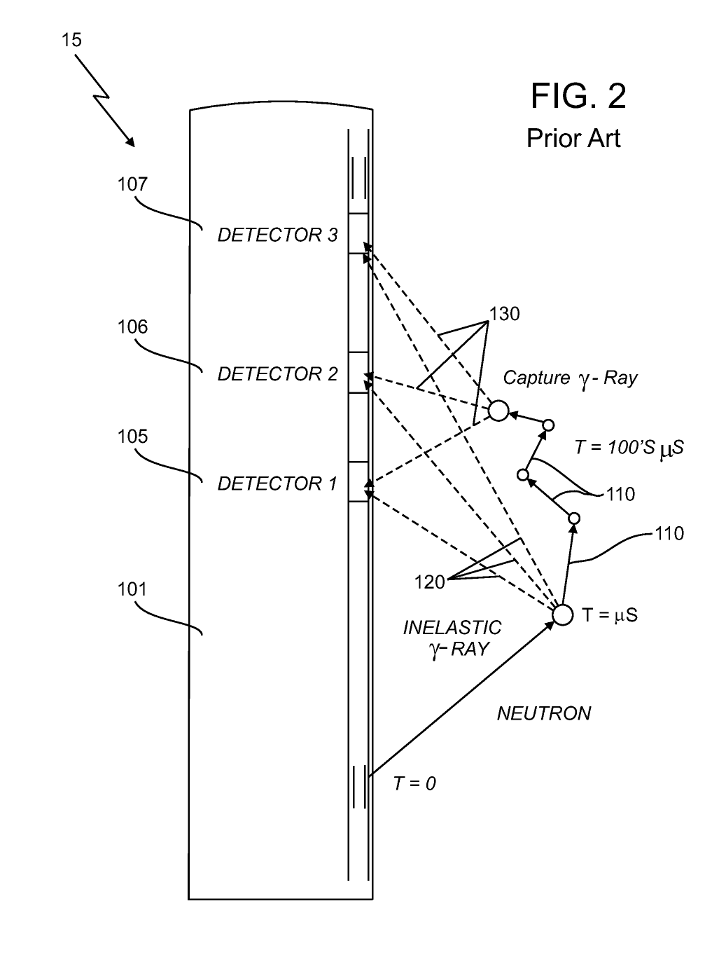

Reference may now be had to FIG. 2, which illustrates an exemplary embodiment of the neutron-interaction logging components in the logging tool 10. The components include a neutron source 101 and three axially aligned spaced apart detectors described below. The number of detectors shown in the embodiment of FIG. 2 is only an example of the number of detectors employed in an embodiment of the present invention. It is not a limitation on the scope of the present invention. The neutron-interaction logging components of the present invention may include one or more detectors. The neutron source 101 in one embodiment may be pulsed at different frequencies and modes for different types of measurements. A short-spaced (SS) detector 105 is closest to the source 101. A long-spaced (LS) detector is denoted by 106, and a furthest detector 107 is referred to as the extra-long spaced (XLS) detector. Fast neutrons (approximately 14 MeV) are emitted from the source 101 and enter the borehole and formation, where they undergo several types of interactions. During the first few microseconds (μs), before they lose much energy, some neutrons are involved in inelastic scattering with nuclei in the borehole and formation and produce gamma rays. These inelastic gamma rays 120 have energies that are characteristic of the atomic nuclei that produced them and a spectrum of the energies of the inelastic gamma rays (i.e., the inelastic gamma ray spectrum) is used to quantify the amount of those nuclei. The atomic nuclei of elements found in this environment and detectable on an inelastic gamma ray spectrum include, for example, aluminum, calcium, carbon, iron, magnesium, oxygen, silicon, sulfur, titanium and some others.

One or more gamma-ray detectors are employed in one or more modes of operation. Such modes include, but are not limited to, a pulsed neutron capture and inelastic mode, a pulsed neutron capture (e.g., sigma) mode, a pulsed neutron inelastic (e.g., carbon/oxygen or C/O) mode, a pulsed neutron holdup imager mode, and a neutron activation mode. In the pulsed neutron capture and inelastic mode, for instance, the tool pulses at 10 kHz and records the full inelastic and capture spectrums for each detector. The inelastic spectrum data and the capture spectrum data are processed to determine the elemental weight fractions (i.e., elemental concentrations expressed as a percent of mass of the sample) of multiple elements including but not limited to aluminum, calcium, carbon, chlorine, hydrogen, iron, magnesium, manganese, oxygen, potassium, silicon, sulfur, thorium and titanium and/or elemental ratios including carbon/oxygen and calcium/silicon from the inelastic spectrum and silicon/calcium from the capture spectrum. In the pulsed neutron capture mode, for example, the tool pulses at 1 kHz, and records a complete time spectrum for each detector. An energy spectrum is also recorded for maintaining energy levels. Time spectra from short-spaced and long-spaced detectors can be processed individually to provide traditional thermal neutron capture cross section sigma information, or the two spectra can be used together to automatically correct for borehole and diffusion effects and produce results substantially approximating intrinsic formation sigma values.

In an embodiment of the present invention, a pulsed neutron generator with improved reliability and higher output is coupled with high-speed downhole microprocessor-controlled drivers and detector electronics. The system supports multiple frequency operation and different detection gate timings to make the different measurements. The modes of operation can be selected from the surface with no need to pull the tool out of the well.

After just a few microseconds (μs), most of the neutrons emitted by the source 101 are slowed by either inelastic or elastic scattering until they reach thermal energies, about 0.025 eV. This process is illustrated schematically in FIG. 2 as the sequence of solid arrows 110. At thermal energies, neutrons continue to undergo elastic collisions, but they no longer lose energy on average. A few μs after the neutron generator shuts off, the process of thermalization is complete. Over the next several hundred μs, thermal neutrons are captured by nuclei of various elements—again producing gamma rays, known as capture gamma rays 130. A capture gamma ray energy spectrum yields information about the relative abundances of these elements. The inelastic gamma rays are depicted by 120. Because inelastic gamma rays 120 are generated before the capture gamma rays 130, it is possible to identify and measure separately to obtain inelastic gamma ray spectra and capture gamma ray spectra.

In general, an electronic pulsed neutron source is used for the neutron source 101. This type of neutron source allows separate measurements of the inelastic gamma ray spectrum and the capture gamma ray spectrum. Spectra are then processed to generate a bulk chemical composition for each measurement point in the borehole 1 and the mineralogical composition is inferred from this bulk chemistry.

One example of a neutron logging tool suitable for producing neutron-induced radiation measurements used in the techniques disclosed herein is the FLEX™ tool available from Baker Hughes Incorporated of Houston, Tex. In one embodiment, this tool includes an electronic pulsed neutron generator and a single scintillation detector with a neutron shield disposed between neutron generator and the detector. The inelastic and capture spectra detected by the detector are distributed into 256 channels to obtain elemental yields that are then converted into dry elemental weight fractions.

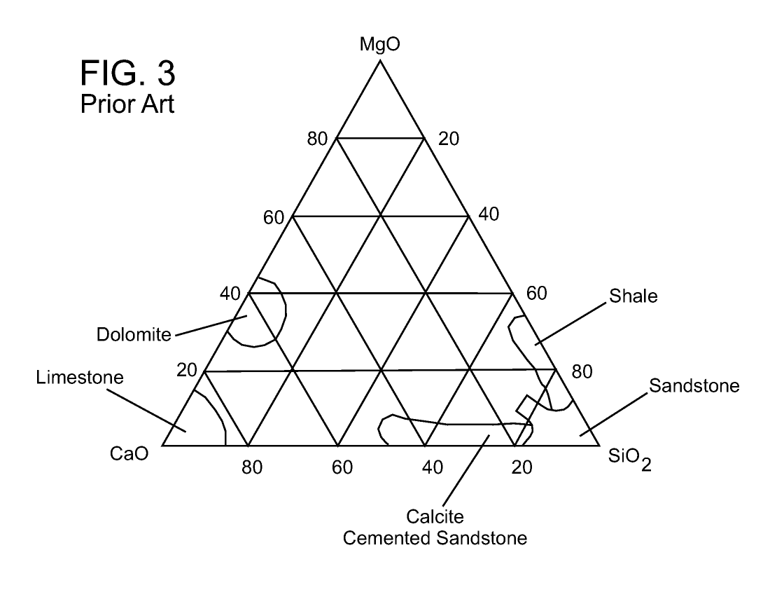

FIG. 3 (from Pemper et al., The Direct Measurement of Carbon in Wells Containing Oil and Natural Gas Using a Pulsed Neutron Mineralogy Tool, SPE 124234, Society of Petroleum Engineers, 2009) presents one example of five lithotype facies defined from neutron-interaction radiation data in tenary plots of CaO/MgO/SiO₂. The five lithotype facies are sandstone, calcite cemented sandstone, shale, limestone and dolomite.

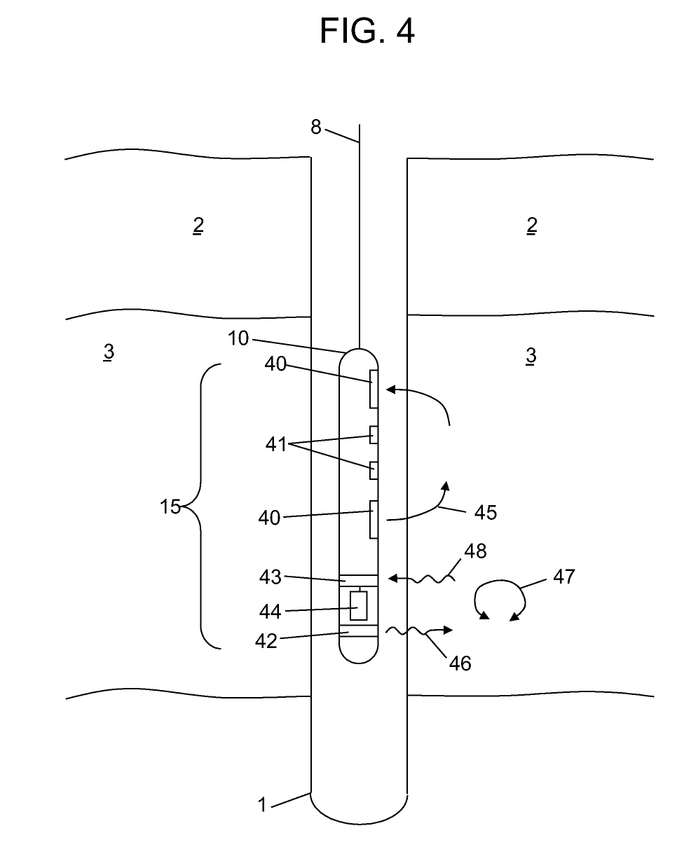

Reference may now be had to FIG. 4, which illustrates an exemplary embodiment of the borehole image logging components in the logging tool 10. In this example, a high-resolution resistivity image is used, but for example, an acoustic image can also be used. The borehole image logging components can be at least one of two types—galvanic and induction. In galvanic logging in one embodiment, alternating current 45 is injected into the formation 3 using at least two electrodes 40 as shown in FIG. 4. Sensing electrodes 41 are used to measure current and/or voltage resulting from the injecting to determine a resistivity or conductivity of the formation 3.

In induction logging, electromagnetic energy 46 is transmitted into the formation 3 using a transmitting antenna 42, which can be a coil. The transmitted electromagnetic energy 46 induces circulating currents 47 or eddy currents in the formation 3 that in turn emit electromagnetic energy 48. The induced electromagnetic energy 48 is received by a receiver antenna 43 and measured with a receiver 44. Because the magnitude of the induced circulating currents 47 is related to a resistivity of the formation 3, the measured electromagnetic energy 48 can be correlated to the resistivity.

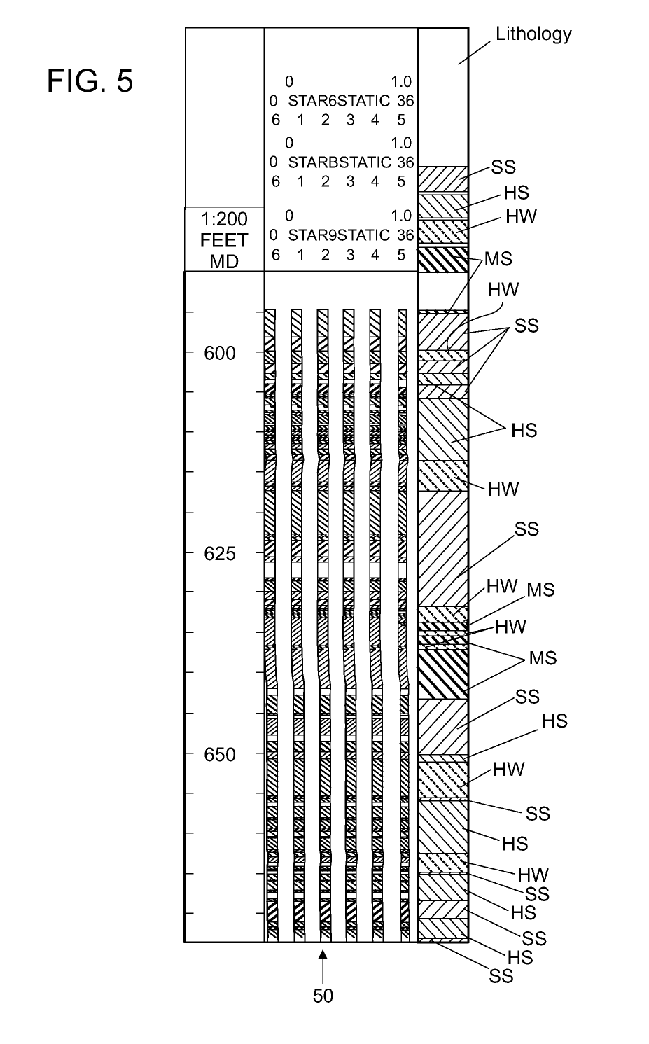

FIG. 5 presents one example of an image 50 of the borehole 1 derived from borehole image logging data. Accordingly, the borehole image log may be referred to herein as an image. The image shows four recognized electrofacies (SS—sandstone; HS—argillaceous sand heterogeneous; HM—sandy mudstone heterogeneous; and MS—mudstone). For each facies, the degree of preservation of bedding and bedding orientation can be determined from the image. The degree of preservation might be interpreted in terms of degree of biturbation or some other physical process.

The vertical resolution of the borehole image logging components (i.e., on the order of less than a centimeter) is generally much better than the vertical resolution of the natural radiation detector and the neutron-interaction radiation logging components (i.e., on the order of a couple of feet). The fine vertical resolution achieved with borehole image logs can be noted in the image log 50 in FIG. 5.

Aspects of processing the natural gamma radiation log, the neutron-interaction radiation log, and the borehole image log to produce the RLIT are now discussed in three stages. Stage one involves merging the radiation logs with the borehole image log. This operation aims at generating one curve including the textural information from image logs (sedimentary facies) with the lithological information from the radiation logs. Lithology data from the radiation logs may be presented as a curve referred to herein as Specific Lithology curve or SLIT curve. Merging the data involves 2 stages: (1) harmonize the sampling rate of the facies determined from images (basically no regular sampling rate) with the radiation records (4 measurements/ft); this involves first resampling both curves so they present common points and (2) merge the information by collating the curves.

Another aspect in stage one processing of the logs involves resampling the facies image curve. The facies from image logs are resampled so they display four measurements per foot in addition to the location of bed-boundaries. The information is copied downward. This means that for bed boundaries at X467.15 ft and X468.98 ft, seven additional points are created respectively at X467.25, X467.50, X467.75, X468.00, X468.25, X468.50 and X468.75 ft. The facies information is copied downward until the next facies boundary is met.

Another aspect in stage one processing of the logs involves resampling the SLIT curve. The SLIT curve comprises four measurements per foot and may miss most of the bed boundaries. A new entry has to be made in the SLIT curve for each bed boundary in the facies curve that occurs in-between two SLIT points. The value for this new entry is copied from the closest SLIT measurement point located below the new entry.

Another aspect in stage one processing of the logs involves merging the data after resampling. Once the two curves have the same number of points located at the same depths, they can be merged point to point. Image log facies are labelled with a specific number to be compatible with the SLIT lithofacies. This number is chosen to offer the best consistency with the SLIT labels for lithology. Combining the information is made by collating the facies number (first) with the SLIT number (second). This results in a four digit number that integrates the textural information from the image log (e.g., heterogeneous, sandy) with the SLIT lithological information (e.g., sandy shale). In this example, the lithology would correspond to a finely bedded succession of thin sandstone and shale layers. At this stage however, no correction is applied yet. This involves: (1) the occurrence of possibly contradictory information at bed boundaries and (2) potentially impossible facies in area where the image log facies and the SLIT disagree. Discrepancies can occur and need to be checked for occurrence. This is the purpose of stage two of the processing.

Stage two processing involves filtering, tuning and quality control. This part of the processing aims at refining, tuning and correcting the raw curve resulting from the first stage. The main corrections concern the location of bed boundaries, the simplification of facies, the correction of discrepancies between image logs and the SLIT curve, and a final check for processing errors.

As previously discussed, the radiation logs suffer from a lower vertical resolution than the image log. This makes radiation logs a poor tool when it comes to locating precisely bed boundaries. In cases of sharp contact with contrasted formations such as, for example, a shale and a sandstone, the radiation logs in the worst of cases, can generate a transition zone and create a layer with a mixed composition as a “shaly sand.” In most of the cases, the radiation logs will pick up correctly the two lithologies but the location of the contact may not be accurate. Due to the sampling rate, it will be approximated to the closest one-eighth of a foot in the best of cases. To the contrary, the image log is both precise and accurate in locating bed boundaries and thin bed intervals. The information from the image log derived facies is thus given higher priority when it comes to locating precisely bed boundaries. Although it does not give any direct indication as to the lithological nature of the two types of beds, it locates the change from one to another.

The bed boundary determined from the image log is considered true, as well as the information on lithology contrast. The SLIT curve is corrected accordingly. In the case of a sharp contact between a shale and a sandstone, the SLIT curve is corrected so the change between shale and sandstone occurs at the bed boundary defined in the image. If intermediate facies occur in the SLIT curve in the vicinity of a bed boundary with homogeneous lithologies on each side of the boundary, the SLIT curve is corrected accordingly. In this case, the intermediate facies is an artefact that can be removed.

Aspects of stage two processing involving thin bed intervals are now discussed. Similar to handling the bed boundaries, the image log information is used to locate the finely bedded intervals. As bed thickness can be measured on the images, it allows discriminating intervals with a homogeneous lithology from intervals constituted by a succession of thin layers with different lithologies. If these layers are thinner than 1-2 ft, the radiation logs will not resolve them individually while they will still be discriminated on the images. A lithological unit, independently of its nature, is qualified as “homogeneous” or “heterogeneous” in the images. Radiation log interpretation, for the same interval, will yield an intermediate facies like “shaly sandstone”—this can be understood as a homogeneous argillaceous sandstone or a heterogeneous succession of thin layers of sandstones and shales. The SLIT curve intermediate facies can thus be qualified as homogeneous or heterogeneous (i.e., a succession of thin beds).

Aspects of stage two processing involving discrepancies are now discussed. Image logs are powerful to locate bed boundaries but by themselves, they give little information as to the lithological nature of the beds. When it comes to the definition of the lithological nature of the formation investigated, the radiation logs provide more accurate information. Accordingly, the SLIT curve is given higher priority when it comes to lithology identification. When discrepancies occur between the image log derived facies and the SLIT curve, the final lithology is defined accordingly to the SLIT curve, provided the mineralogy was calibrated against X-ray diffraction (XRD) data.

When a strong discrepancy occurs, as for example the image log recording a sand and the SLIT curve indicating a shale or a sandy shale, the lithology is defined according to the SLIT curve. In that case, the formation would be recorded as a shale or a sandy shale. The information added by the image log is of textural order—the layer is probably homogeneous and may be cemented. It is, however, advised to check both curves prior to making a decision and the interval can be marked for further investigation.

Aspects of stage two processing involving tuning are now discussed. Merging the facies curve and the SLIT curve multiplies the number of facies, some of which are so close as to make very little difference. Therefore, in one embodiment, these facies can be grouped under one label. The tuning operation includes identifying the different facies resulting from the merging and in understanding their geological meaning. The labels describing similar lithologies are grouped together under one single label. The series of data is then filtered to remove the redundant labels. This allows limiting the final number of different lithofacies and makes the final plot easier to read.

Aspects of stage two processing involving quality control (QC) are now discussed. This is the final check for data quality. As a certain number of operations were carried out on the initial logs, some of them implying the operator to make a decision as to which information to give priority, it is necessary to check that no error was introduced. The main sources of errors concern the depth of measurement points (introduced during resampling), redundant labels not removed, inadequate boundary correction, error in labelling during curve merging (e.g., using the SLIT label instead of the image derived facies as first part of the merged label). Thus, potential error sources are multiple. Hence, it is important to thoroughly check the merged and corrected data.

The outcome of this last QC procedure is the RLIT curve (Refined LIThology) which integrates the SLIT lithology with the image log textural information at a resolution intermediate between the SLIT and the image log. The resolution of the RLIT curve is strongly dependent on the resolution of the borehole image interpretation.

Aspects of stage three processing, which involve plotting and displaying, are now discussed. This is the last part of the process. The main issue is to use a curve terminology that represents the facies determined in the previous stages and that can be used as a standard by the analyst.

Plotting is similar to the plotting of the SLIT curve. Like the SLIT curve, the RLIT curve is a collection of number codes associated with depth. Each code corresponds to a lithotype facies (see Table 1 for non-limiting examples of facies description). A series of functions are defined to identify the codes and relate them to a display. The same representation as in the SLIT display is used for the main lithologies—a colour scheme (or visual texture) and variations in width are used to represent the information added by borehole images.

TABLE 1

| FACIES NAME | DESCRIPTION |
|---|---|
| SST-Qz | Quartzic sandstone, homogeneous (arenite) |
| SST-Fp | Feldspatic sandstone, homogeneous (arkose) |
| SST-Cl | Argillaceous sandstone, homogeneous |
| SST-Qz-BT | Quartzic sandstone, bioturbated |
| SST-Fp-BT | Feldspatic sandstone, bioturbated |
| SST-Cl-BT | Argillaceous sandstone, bioturbated |
| SST-Cl-TB | Sandstone with thin shale layers (thin beds) |
| MDT | Mudstone, homogeneous |
| MDT-BT | Mudstone, bioturbated |
| MDT-TB | Mudstone with thin sandstone layers (thin beds) |
| SST-Carb | Calcite-cemented sandstone, homogeneous |
| SST-Carb-BT | Calcite-cemented sandstone, bioturbated |
| SST-Carb-TB | Sandstone with thin layers of limestone (thin |
| | beds) |
| MDT-Carb | Calcite-cemented mudstone, homogeneous |
| MDT-Carb-BT | Calcite-cemented mudstone, bioturbated |
| MDT-Carb-TB | Mudstone with thin layers of limestone (thin |
| | beds) |

The processes disclosed above may be implemented automatically by a processor to increase processing speed or manually or by some combination thereof.

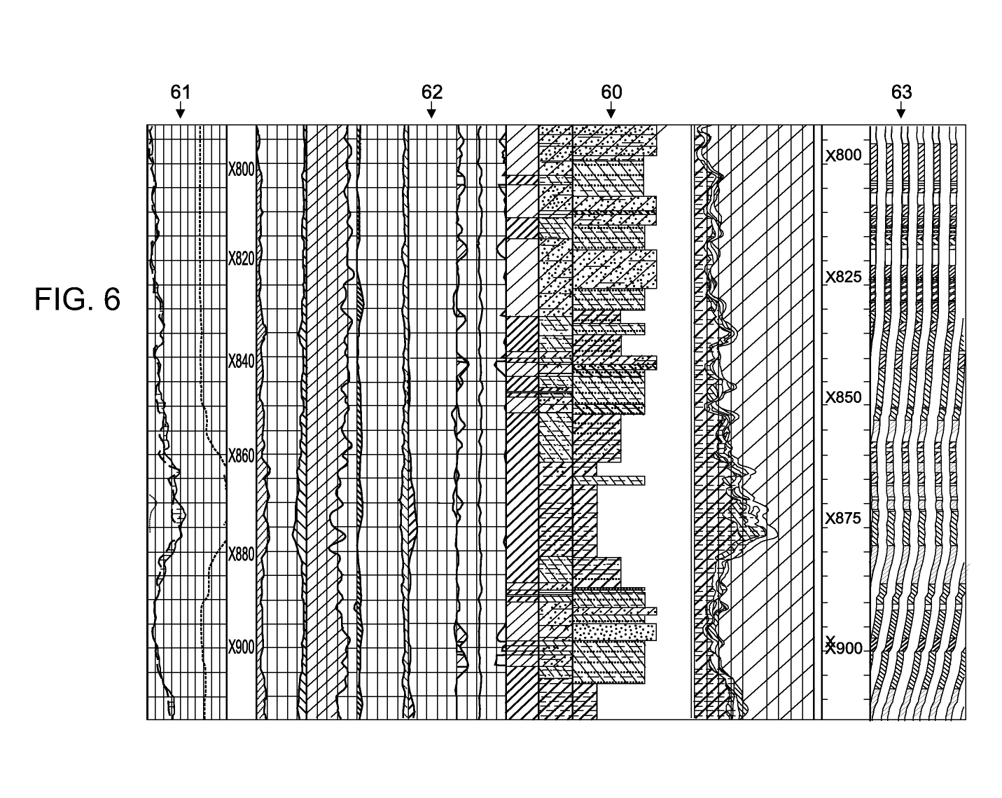

FIG. 6 presents one example of an RLIT curve 60 plotted with other logs such as a natural gamma radiation log 61, a neutron-interaction radiation log 62 and a borehole image 63. The RLIT curve 60 represents the main lithologies using background color, visual texture, and variations in width.

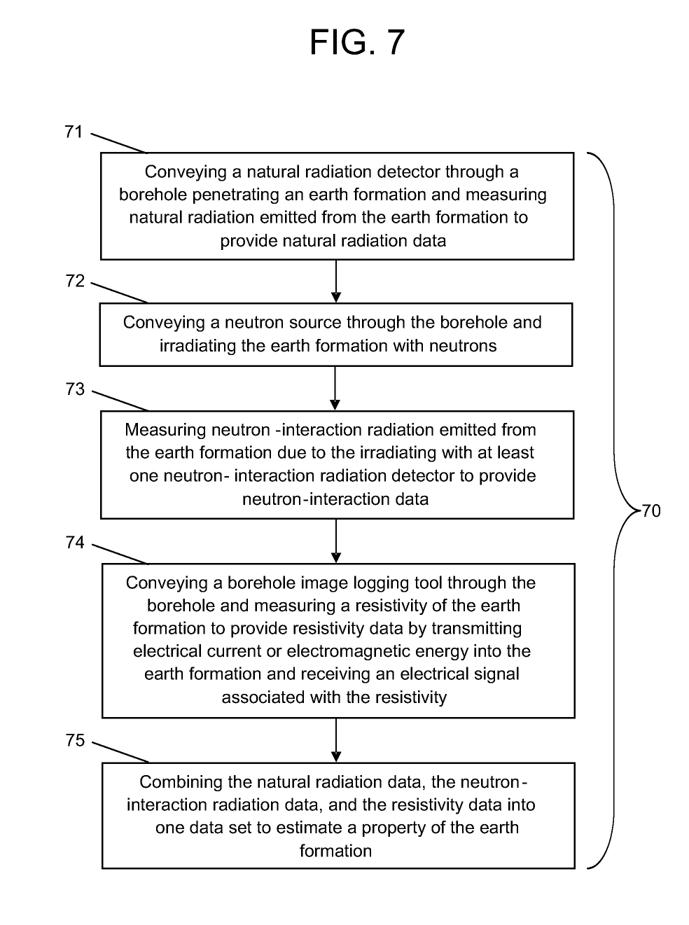

FIG. 7 presents one example of a method 70 for estimating a property of the formation 3. The property in this example is lithotype facie as a function of depth. The method 70 calls for (step 71) conveying the natural radiation detector through the borehole 1 and measuring natural radiation emitted from the earth formation to provide natural radiation data. Further, the method 70 calls for (step 72) conveying the neutron source 101 through the borehole 1 and irradiating the earth formation 3 with neutrons. Further, the method 70 calls for (step 73) measuring neutron-interaction radiation emitted from the earth formation due to the irradiating with at least one neutron-interaction radiation detector such as 105, 106 or 107 to provide neutron-interaction data. Further, the method 70 calls for (step 74) conveying a borehole image logging tool through the borehole and measuring a resistivity of the earth formation to provide resistivity data by transmitting electrical current or electromagnetic energy into the earth formation and receiving an electrical signal associated with the resistivity. Further, the method 70 calls for (step 75) combining the natural radiation data, the neutron-interaction radiation data, and the resistivity data into one data set to estimate the property.

In support of the teachings herein, various analysis components may be used including a digital and/or an analog system. For example, the downhole electronics 13 or the computer processing system 5 may include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, motive force (such as a translational force, propulsional force or a rotational force), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any device, device component, combination of devices, media and/or member that may be used to convey, house, support or otherwise facilitate the use of another device, device component, combination of devices, media and/or member. The logging tool 10 is one non-limiting example of a carrier. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first,” “second” and “third” are used to distinguish elements and are not used to denote a particular order.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for estimating a property of an earth formation penetrated by a borehole, the method comprising:
conveying a natural radiation detector through the borehole and measuring natural radiation emitted from the earth formation to provide natural radiation data;
conveying a neutron source through the borehole and irradiating the earth formation with neutrons;
measuring neutron-interaction radiation emitted from the earth formation due to the irradiating with at least one neutron-interaction radiation detector to provide neutron-interaction data;
conveying a borehole image logging tool through the borehole and measuring a resistivity of the earth formation by transmitting electrical current or electromagnetic energy into the earth formation and receiving an electrical signal associated with the resistivity due to the transmitting to provide resitivity data; and
combining the natural radiation data, the neutron-interaction radiation data, and the resistivity data into one data set as a function of depth to estimate the property.

2. The method of claim 1, wherein the property is a lithology as a function of depth with at least one boundary delineating a change in the lithology.

3. The method of claim 2, wherein the natural radiation data comprises first lithology data as a function of depth, the neutron-interaction radiation data comprises second lithology data as a function of depth, and the resistivity data comprises third lithology data as a function of depth.

4. The method of claim 3, wherein the resistivity data comprises a depth associated with a boundary between changes in resistivity.

5. The method of claim 3, further comprising associating at least one of the first lithology data, the second lithology data, and the third lithology data with a first formation lithology on one side of the boundary and a second formation lithology on the other side of the boundary.

6. The method of claim 3, further comprising crosschecking the first lithology data, the second lithology data, and the third lithology data against each other to determine any discrepancies.

7. The method of claim 6, wherein the discrepancies are determined at least one of manually by an analyst and automatically by a processor.

8. The method of claim 1, further comprising resampling at least one of the natural radiation data, the neutron-interaction radiation data, and the resistivity data to provide common points as a function of depth.

9. The method of claim 8, further comprising plotting the common points as a function of depth wherein each common point comprises a data number comprising a depth and a final lithology associated with the depth.

10. The method of claim 9, wherein the data number of at least one of the common points further comprises a boundary of the final lithology associated with the depth.

11. The method of claim 9, wherein a plot resulting from the plotting comprises at least one of a unique color and a unique visual texture associated with each unique final lithology.

12. An apparatus for estimating a property of an earth formation penetrated by a borehole, the apparatus comprising:
a natural radiation detector conveyable through the borehole and configured to measure natural radiation emitted from the earth formation to provide natural radiation data;
a neutron source conveyable through the borehole and configured to irradiate the earth formation with neutrons;
at least one neutron-interaction radiation detector configured to measure neutron-interaction radiation due to the irradiated to provide neutron-interaction radiation data;
a borehole image logging tool conveyable through the borehole and configured to measure a resistivity of the earth formation by transmitting electrical current or electromagnetic energy into the earth formation and receiving an electrical signal associated with the resistivity to provide resistivity data; and
a processor configured to combine the natural radiation data, the neutron-interaction radiation data, and the resistivity data into one data set as a function of depth to estimate the property.

13. The apparatus of claim 12, wherein the neutron source is a pulsed-neutron source and the neutron-interaction radiation results from at least one of inelastic scattering and thermal neutron capture.

14. The apparatus of claim 13, wherein the at least one neutron-interaction radiation detector comprises a first detector spaced a first distance from the pulsed-neutron source and a second detector spaced a second distance from the pulsed neutron source.

15. The apparatus of claim 14, wherein the property of the formation is derived from at least one of a ratio of counts due to inelastic scattering received by the second detector to the counts received by the first detector and a ratio of counts due to thermal neutron capture received by the second detector to the counts received by the first detector.

16. The apparatus of claim 12, wherein the natural radiation detector, the neutron source, the at least one neutron-interaction radiation detector, and the borehole image logging tool are disposed at a carrier.

17. The apparatus of claim 16, wherein the carrier comprises at least one of a wireline, a slickline, a drillstring, and coiled tubing.

18. A non-transitory computer-readable storage medium comprising computer-executable instructions for estimating a property of an earth formation penetrated by a borehole by executing a method comprising:
measuring natural radiation emitted from the earth formation to provide natural radiation data;
measuring neutron-interaction radiation emitted from the earth formation due to irradiating the formation with neutrons to provide neutron-interaction data;
measuring a resistivity of the earth formation to provide resistivity data; and
combining the natural radiation data, the neutron-interaction radiation data, and the resistivity data into one data set as a function of depth to estimate the property.
